(19) United States
(12) Patent Application Publication
(10) Pub. No.: US 2014/0372173 A1
(43) Pub. Date: Dec. 18, 2014

(54) HOME INVESTMENT REPORT CARD

(71) Applicant: Rajasekhar Koganti, Vijayawada (IN)

(72) Inventor: Rajasekhar Koganti, Vijayawada (IN)

(21) Appl. No.: 13/916,819

(22) Filed: Jun. 13, 2013

(51) Int. Cl. G06Q 50/16; G06Q 30/02

(52) U.S. Cl. CPC G06Q 50/16; G06Q 30/0202
USPC 705/7.31

(57) ABSTRACT

A facility for forecasting the relative change in future value of a distinguished home located in a distinguished geographic area is described. Utilizing a combination of statistical and mathematical models, the facility reports the acquired relative change in future value for the distinguished home in the form of the “Home Investment Report Card” which provides easy to use information on all of the key variables affecting relative change in price through the use of letter grades. The facility then provides the Final Grade, which is the actual estimate for the distinguished home.

### CROSS-REFERENCE TO RELATED APPLICATION(S)

This application claims the benefit of U.S. Provisional Application Ser. No. 61/659,413 filed on Jun. 13, 2012, entitled “HOME INVESTMENT REPORT CARD,” which is hereby incorporated by reference.

A facility for forecasting the relative change in future value of a distinguished home located in a distinguished geographic area is described. The facility receives the home address for the distinguished home. To obtain the relative change in future value for the distinguished home located in a distinguished geographic area, the facility implements the analysis in two steps. In the first step, the facility forecasts the relative change in future value for the average home in a geographic location by applying a suite of statistical models based on understanding how long it takes key macro and micro economic variables to work their way through the system. In the second step, the facility classifies homes into condominiums, single family and multi-family homes and then applies the forecast derived in the first step on a suite of quantitative-models with predicted weights around the standard deviations for the received home address to obtain an overall relative change in the future value for the distinguished home in the distinguished geographic location. The facility reports the acquired relative change in future value for the distinguished home in the form of the “Home Investment Report Card” which provides easy to use information on all of the key variables affecting relative change in price through the use of letter grades. The facility then provides the Final Grade, which is the actual estimate for the distinguished home.

### TECHNICAL FIELD

The described technology is directed to the field of electronic commerce techniques, and, more particularly, to the field of electronic commerce techniques relating to real estate.

### BACKGROUND

From the Great Depression of the 1930s through the Credit Crunch of 2008, it was “common wisdom” in the U.S. that if you invested money into a residential real estate property (e.g., home), and left it there long enough, you would make a profit on your investment. Using this “common wisdom”, everyday American citizens made the largest investments of their lives with very little information about the houses they were buying. In fact, the average home buyer today still receives far less information about the potential future value of an investment in a house then they would when buying a stock, where most investors would read an investment report that provides an analysis of whether the security might go up or down and by how much.

In our post Credit Crunch economy, it is clear that housing prices are no longer just going up over the long term. In fact, with 50% of individual home prices still declining, the biggest question that potential homebuyers have is whether the value of the home an individual or institution want to buy has stabilized or whether it is still falling.

Our facility attempts to answer this question for potential homebuyers, homeowners, lenders and other constituents of the residential housing market. We provide an assessment of the key economic variables effecting demand and supply for a house as well as an actual forecast for that house. In summary, it can be useful to be able to accurately forecast the value of residential entities where, as examples, by using accurate forecasts for homes: taxing bodies can plan setting property tax levels to meet revenue targets; sellers and their agents can optimally set listing dates; buyers and their agents can determine appropriate offer dates; insurance firms can properly hedge their insured assets; and mortgage companies can properly determine the risks and returns of the assets securing their loans.

### BRIEF DESCRIPTION OF THE DRAWINGS

FIG. 1 is a block diagram showing some of the components typically incorporated in at least some of the computer systems and other devices on which the facility executes.

FIG. 2 is a flow diagram showing steps typically performed by the facility to automatically forecast relative change in the future value for homes in a geographic area.

### DETAILED DESCRIPTION

### Overview

Our analytical approach is a suite of statistical and percentile models, which at their essence; predict the lags and impact of key economic variables as well as home attributes on relative changes in distinguished house prices in the distinguished geographic locations. This is different from other approaches in the marketplace. The two approaches currently used in the marketplace are:
1) Simple regressions that merely look to past relative changes in home prices and project continuations of those curves are used at the city, state and country levels.
2) Automated Valuation Models (AVMs) which are attempts to automate the appraisal process by picking several comparable homes that have recently sold in the area and triangulating the value of the home in question are used at the individual house level.

Both of these approaches do not predict relative changes in value at a home by home level and have not been proven to be nearly as reliable as the Pricing Nation approach of understanding the lags of key economic variables and their impacts on the housing system to forecast change in future home values at the MSA, State, Zip, County and Home levels.

In view of the shortcomings of conventional approaches to predict relative changes in valuing the houses discussed above, the inventors have recognized that a new approach to predict relative changes in the valuation of houses that was more universally accurate, less expensive, and more convenient for everyday consumers would have significant utility.

A software facility for automatically determining a relative change in the future value for a home (“the facility”) is described.

In some embodiments, the facility establishes, for each of a number of geographic regions, a model of relative change in future housing prices in that region. This model transforms inputs corresponding to economic variables of a geographic area and home attributes into an output constituting a predicted relative change in the future value of a home in the corresponding geographic area having those attributes. In order to determine the relative change in the future value of a particular home, the facility selects the statistical model based on economic variables for average homes in the geographic region containing the home, and subjects the percentile model based on the home's attributes to the selected model.

In some embodiments, the model used by the facility to value homes is a complex model made up of (a) a geographic model producing a forecast for an average relative change in the future value for the home in the geographic region, together with (b) a meta-model that uses a number of percentile-models with predicted weights on the basis of homes' attributes to which the facility combines to forecast a relative change in future valuation of the distinguished home in the distinguished geographic location by the complex model.

In various retail embodiments, the facility presents this relative change in future value to the owner of the home, a prospective buyer of the home, a real estate agent, or another person interested in the relative change in the future value of the home or the relative change in the future value of a group of homes including the home.

In some embodiments, the facility regularly applies its model to the attributes of a large percentage of homes in a geographic area to obtain and convey an average relative change in future value for the homes in that area. In some embodiments, the facility periodically determines an average relative change in value for the homes in a geographic area, and uses them as a basis for determining and conveying a home future value index for the geographic area.

Because the approach employed by the facility to determine the relative change in the future value of a home does not rely on any one single variable, it can be used to accurately forecast virtually any homes' relative change in future value whose attributes are known or can be determined. Further, because this approach does not require the services of a professional appraiser, it can typically determine a home's value quickly and inexpensively, in a manner generally free from subjective bias.

### Relative Change in Future Home Valuation

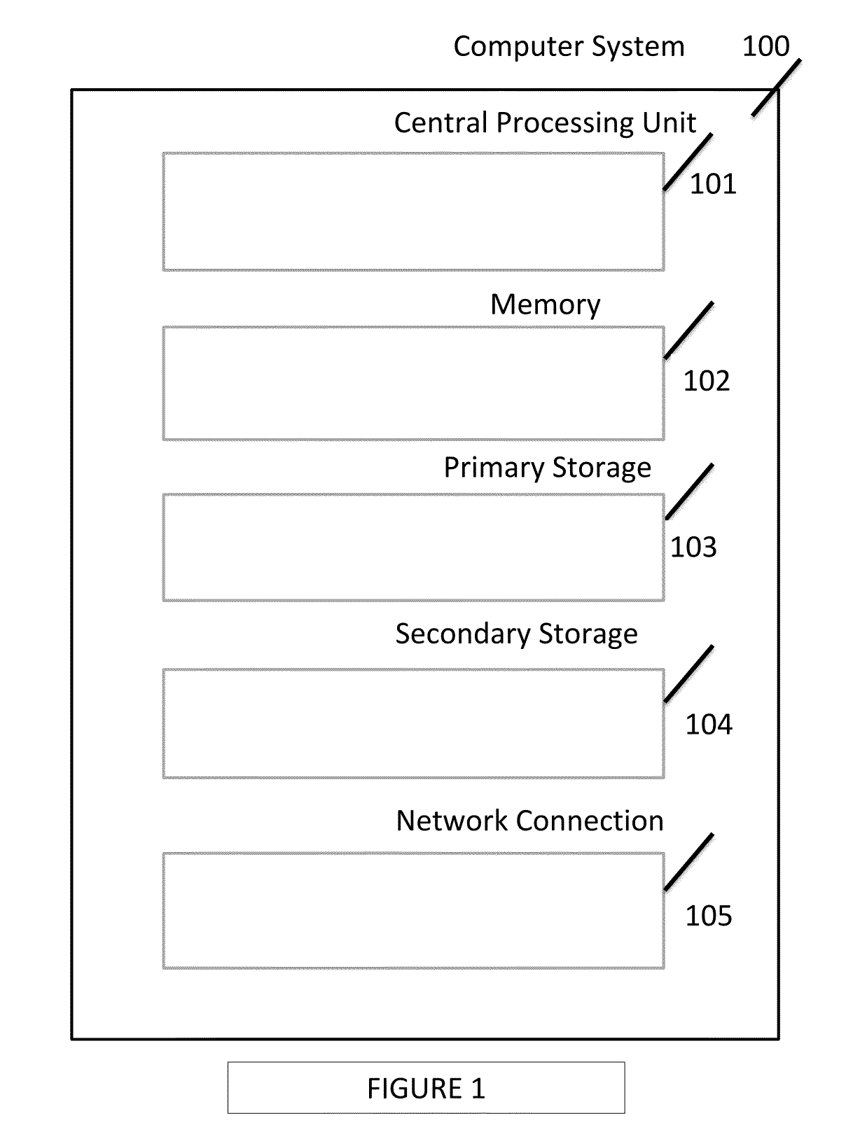

FIG. 1 is a block diagram showing some of the components typically incorporated in at least some of the computer systems and other devices on which the facility executes. These computer systems and devices 100 may include one or more central processing units (“CPUs”) 101 for executing computer programs; a computer memory 102 for storing programs and data—including data structures, database tables, other data tables, etc.—while they are being used; a primary storage device 103, such as a hard drive, for secondary storing programs and data; a secondary storage drive 104, such as a CD-ROM drive, for reading programs and data stored on a computer-readable medium; and a network connection 105 for connecting the computer system to other computer systems, such as via the Internet, to exchange programs and/or data—including data structures. In various embodiments, the facility can be accessed by any suitable user interface including Web services calls to suitable APIs. While computer systems configured as described above are typically used to support the operation of the facility, one of ordinary skill in the art will appreciate that the facility may be implemented using devices of various types and configurations, and having various components.

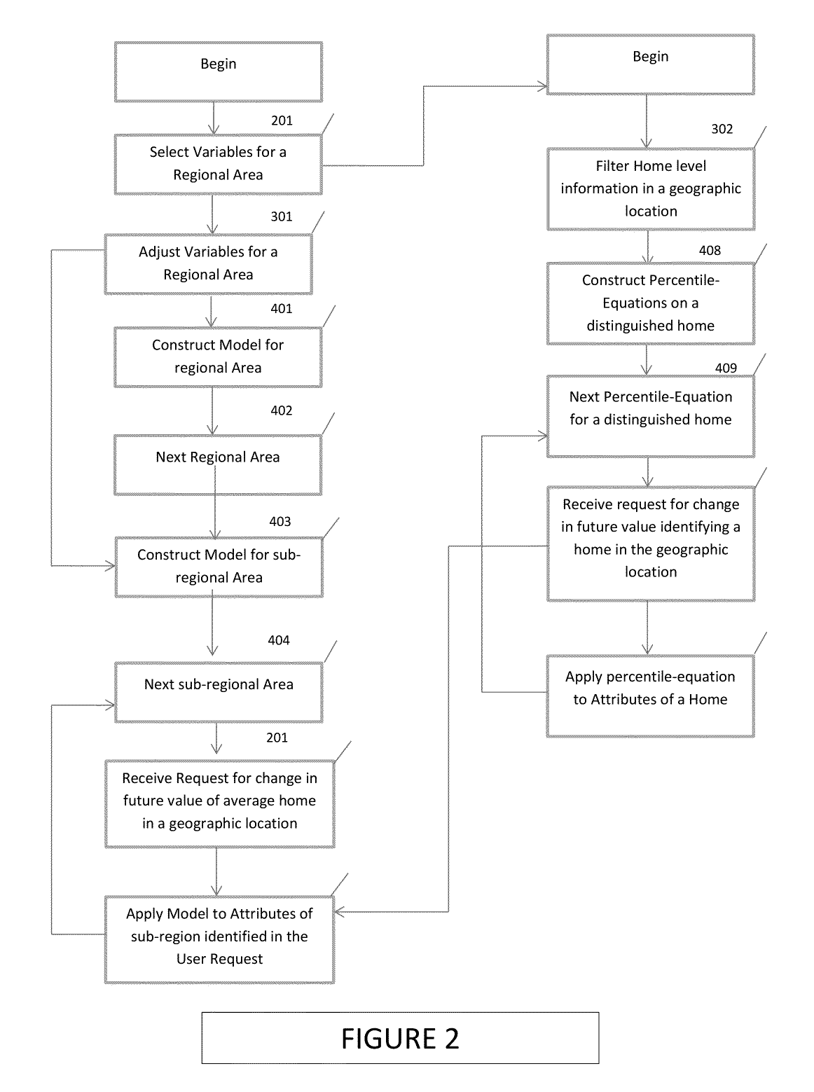

FIG. 2 is a flow diagram showing steps typically performed by the facility to automatically forecast the relative change in future value for the distinguished home in a geographic area. The facility may perform these steps for one or more homes in one or more geographic areas, including neighborhood, city, county, state, country, etc. These steps may be performed periodically for each geographic area, for example, on a daily basis. Constructing regional and sub-regional models that forecast the average relative change in the future value for homes together with percentile models that forecast relative change in the future value for the distinguished home in the distinguished location is sometimes referred to as “training” these models.

In step 201, the facility retrieves information about economic variables in Table 1 and home level attributes in Table 2 from the database 2A. Typically, this retrieval is constrained in two ways: to economic variables and home level attributes data in a particular period of time, such as one year ago to the present time; and the geographical location of the economic variables and home level attributes information, such as a particular census tract. In some embodiments, the facility iterates over each geographic area for which it has data in order to construct a different model for each such home in each such geographic area.

Table 1 includes the following economic variables but is not limited to: Consumer price index; Average household income; Median household income; Household non-housing wealth; Home equity lines outstanding at commercial banks; Total commercial bank assets; Effective apartment rent; Households; Population by age cohort; Foreign immigration; Unemployment rate; S&P 500 stock index; Treasury interest rates; Effective mortgage rate; Effective personal income tax rate; Property tax rate; Net migration; Affordability index; Housing starts; Housing permits; Composite effective mortgage interest rate; Consumer debt obligations ratio; Debt service burden; Household net worth; Rental vacancy rate; Household financial obligations ratio; Debt-to-income ratio; State percentage of loans in foreclosure; Housing starts; Residential Permits; Residential Vacancy rate; Business Vacancy Rate

Table 2 includes the following homes' attributes but is not limited to Record Type; Property Identification Number; Owner #1'First Name; Owner #1's Last Name; Owner #2's First Name; Owner #2's Last Name; Property State; Property County; Property Town; Full Property Street Address; Property Street Name; Property Zip Code+4; Census Tract; Building's Census Block; Property Owner's Full Street Address; Property Owner's Street Name; Property Owner's City; Property Owner's State; Property Owner's Zip Code; Property Use Code; Property Usage Name; Total Assessed Value of Property & Land; Automated Value Model; Size of the Property's entire lot, including land & building (in this case they are all condos so same as next field); Style of Building (with houses you'll see “colonial, cape, etc.”); Gross Building Area; Interior Square Footage; Number of Floors in that Property (in this case in that condo, not the building the condo is in); The year the building was built; Year of any recorded renovations (not always captured by appraisers); Total Number of Bedrooms; Total Number of Bathrooms; Last Recorded Sale Date of that Property; Last Recorded Sale Price of that Property; Last Sale Type—if described in sales transaction; Last Sale—Book Number; Last Sale—Page Number

FIG. 2 and Table 1 & Table 2 contents and organization discussed above are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; etc.

In step 301, the facility adjusts economic data points retrieved by the facility in order to normalize them for the dates on which the data points are given. In order to do so, the facility identifies the seasonality and trend among the values for each geographic location represented in the training data. The facility then adjusts the values by modeling seasonality and trends from a year within the geographical location in the year in which the variable's performance was measured. The facility stores such values 3A determined in step 301 in a model database 2B that stores various components of the future valuation model constructed in accordance with FIG. 2

In step 302, the facility filters out all the home level data records that it regards as outliers. In some embodiments, the facility filters out data records such as the following where, for example, tax assessed value not within a predetermined acceptable level in the geographic area; records that appear to have occurred before the home was remodeled. Those skilled in the art will appreciate that a variety of other outlier filters could be used.

In step 303, the facility filters out any home level that is not the most recent information of the home that it identifies. In step 304, for each unfiltered home level record, if attributes from public records for the home match attributes received from users, then the facility continues in step 304, else the facility continues in step 305.

In step 304, the facility creates a model for adjusting tax assessments in cases where users have updated the physical facts of the home in accordance with relative changes to the home not reflected in the tax assessments. In doing so, the facility uses only public record information for homes. In step 305, the facility verifies whether the owner or his agent suggested relative changes to the existing public records, and if so, the facility adds the difference between the resulting information to the public record for the distinguished home.

### Models for Relative Changes in the Future Homes'Values in a Geographical Locations

The underlying foundation of our modeling approach is that all homes within a geographic location are related to that geographic location in terms of home price relative changes, thus, the facility analyzes key economic variables, like relative changes in employment, that are stored in our databases 2A and 2B to determine their effect on future housing price relative changes on average in the geographic location. Unlike the stock market where millions of investors buy and sell securities continuously and information instantaneously affects prices of securities, the housing market is not as efficient. If employment dramatically goes up in a geographic location, it may not change the price of housing the next day, week or even month. However, it may change the prices for housing in a highly predictable way in terms of level and timing. The timing of this change is its lag in the system.

### Metropolitan Statistical Area (MSA), Core Based Statistical Area (CBSA) Model

The core forecasting model is at either the MSA or CBSA geographic level. In step 401, the facility determines lags and magnitude of change for key economic variables (i.e. vacancies) and macroeconomic variables (i.e. mortgage rates). The facility then integrates the lags and magnitudes of these variables into a regression model that forecasts the relative changes in housing values on average in a geographic location for a particular time period that include but not limited to twelve months, twenty four months, and sixty months into the future.

The facility stores the regression model 402 trained in step 401 in the model database. After step 402, the facility continues in step 403.

### Sub-MSA/CBSA Region Forecasts

The prices in a sub-region of a MSA/CBSA are co-integrated with the MSA/CBSA, and the forecast can be derived from the difference between the sub-region and the MSA/CBSA. In step 403, the facility then built regression models for the relative changes in home prices on average within MSA/CBSA that include zip codes, counties, census tracts, towns, neighborhoods, and cities.

The facility built a regression model by integrating the results of the respective MSA/CBSA model and impact for all of the relevant microeconomic variables within the respective sub-regions to forecast relative changes in home prices for a particular time period that include but not limited to twelve months, twenty four months, and sixty months into the future for the average home in each sub region.

The facility stores the regression model 404 trained in step 403 in the model database. After step 404, the facility continues in step 405.

### State Level Forecasts

The state model, like the sub-region model, hinges off the MSA/CBSA forecasts. In step 405, the facility develops a model to predict the relative change in future value of the average house in each state.

The facility built a regression model by integrating the results of the respective MSA/CBSA model and impact for all of the relevant microeconomic variables within the respective state to forecast relative changes in home prices for a particular time period that include but not limited to twelve months, twenty four months, and sixty months into the future for the average home in each state.

The facility stores the regression model 406 trained in step 405 in the model database. After step 406, the facility continues in step 407.

### Home Level Forecasts

Since the facility develops estimates for relative changes in price for each home within a granular geographic location, it could no longer use regression models, as each individual home does not “trade” frequently enough. In step 408, the facility examines the degree to which a distinguished home with distinguished characteristics moves with relative changes in future home prices on average in the geographical location.

Cluster analysis is a classification methodology that identifies natural groupings of objects (in this case, specific homes' prices with specific homes' attributes), so that objects in the same group are more like one another than they are like objects in other groups. The measure used in cluster analysis is Euclidean distance, which is the square root of the sum of the squared differences between homes' prices with specific characteristics and their respective group center. Thus, for limited annual data, the distance between 2 homes is the Euclidean distance in 10-dimensional space. Two homes among the homes being sold with exactly the same series of attributes and prices will have a metric distance of zero. Two homes among the homes being sold whose prices move in opposite directions will have a relatively large distance measure in terms of attributes.

Using a sample of large pseudo-histories as shown in FIG. 3 by sampling with replacement from the entire set of estimated price-patterns across distinguished homes with distinguished characteristics with respect to the average home in a geographic location, the facility constructs clusters of distinguished homes with distinguished characteristics whose relative changes in price patterns are most similar to one another and most different from the relative changes in price patterns with respect to the average home in the geographic location. In this way, one home can cluster with another in as many as thousands of the pseudo-histories-strongly suggesting that the underlying price-appreciation patterns are truly similar—or as few as none of them—suggesting that the underlying relative change in price patterns are not at all similar. The relative frequency with which each pair of homes clusters together measures the similarity of the price-appreciation patterns with respect to the average home in the geographic location.

In some embodiments, the facility filters rows from the basis table with selling prices that reflect particularly rapid appreciation or depreciation of the average home in the granular-geographic location. For example, in some embodiments, the facility filters from the basis table recent sales whose selling prices represent more than 50% annual appreciation or more than 50% annual depreciation. In other embodiments, however, the facility initially performs the filtering clustering above, and then uses the filtered basis table to construct a cluster analysis.

Unlike correlation studies, the facility did not require long time-series for accuracy. It used a bootstrapping method to test hypotheses such as whether a certain house-price-appreciation pattern is similar to the pattern of other houses in the geographic location.

Bootstrapping allows the facility to perform statistically significant tests and construct confidence intervals around a test statistic even when the distribution of the test statistic is unknown. In this case, the test statistic is a matrix of observations on the frequency with which two homes that are available for sale and eventually sold cluster together, suggesting that the certain home-price-appreciation patterns are more similar to each other than to the patterns of other homes in other areas. To perform a statistical test of these hypotheses, the facility used a statistical procedure called the Wilcoxon rank-sum test, which gives a test statistic with the familiar standard normal distribution that enables us to perform a straightforward hypothesis test.

In forecasting relative changes in prices on a home-by-home case; however, knowing merely of the existence of clusters among some features is just a first step. It is far more important to reveal quantitatively, and as specifically as possible, which features contribute to which dependencies as a second step. Having performed this second step, modeling a home becomes possible, in a way that describes the respective underlying data quantitatively as well as qualitatively.

Thus, in order to gain the full practical potentials from cluster analysis, the facility implements the second step and obtains a set of percentile equations with predicted weights that are implemented on homes to identify the relative change in the future value of a distinguished home in the distinguished geographic location. Such percentile equations include the following, but are not limited to, scarcity percentile (Houses with Same Number of Bedrooms for sale as selected House/All Houses in granular geographic location with same number of bed rooms as selected House), “luxury percentile” (Assessed Value/(Living Area+(0.5*Lot Size)), and so on.

The facility stores such percentile models and weights 409 trained in step 408 in the model database. After step 409, the facility continues in step 410

In step 410, the facility implements the meta-model by flanking each percentile-equation around the standard deviations of the relative change in future value for the average home in the geographic location to develop a unique estimate of price relative changes per house for a particular time period that include but not limited to twelve months, twenty four months, and sixty months into the future by utilizing the score for the percentile equations with predicted weights that were constructed in step 409; the facility applies each of the generated percentile-models to each of the homes such that each percentile-model produces a relative change in future valuation for each of these homes.

The facility stores the meta-model 411 and the associated data 412 generated in step 201 in the model database.

At the conclusion of these steps, the model database contains models 402, 404, 406, 409 and data in our databases 2A and 2B.

### CONCLUSION

It will be appreciated by those skilled in the art that the above-described facility may be straightforwardly adapted or extended in various ways. For example, the facility may use a wide variety of modeling techniques, house attributes, and/or data sources. The facility may display or otherwise present its relative change in future home valuations in a variety of ways that include the form of the “Home Investment Report Card” which provides easy to use information on all of the key variables affecting change in price through the use of letter grades. While the foregoing description makes reference to particular embodiments, the scope of the invention is defined solely by the claims that follow and the elements recited therein.

### REFERENCES

1. Andersen; Timothy J.; et al. “Collecting and representing home attributes” U.S. Patent 20080077458, Filed on Sep. 19, 2006 and Issued on Mar. 27, 2008

2. Arrow, Kenneth J., Robert Forsythe, Michael Gorham, Robert Hahn, Robin Hanson, John O. Ledyard, Saul Levmore, Robert Litan, Paul Milgrom, Forrest D. Nelson, George R. Neumann, Marco Ottaviani, Thomas C. Schelling, Robert J. Shiller, Vernon L. Smith, Erik Snowberg, Cass R. Sunstein, Paul C. Tetlock, Philip E. Tetlock, Hal R. Varian, Justin Wolfers and Eric Zitzewitz. 2008. \The Promise of Prediction Markets.” Science 320(5878):877 {878.

3. Blum, A., Langley, P., “Selection of relevant features and examples in machine learning” Journal of Artificial Intelligence—Special issue on relevance archive Volume 97 Issue 1-2, December 1997 Pages 245-271 Elsevier Science Publishers Ltd. Essex, UK

4. Capozza, D., Hendershott, P., Mack, C “An Anatomy of Price Dynamics in Illiquid Markets: Analysis and Evidence from Local Housing Markets” Real Estate Economics, Volume 32, Issue 1, pages 1-32, March 2004

5. Croissant, Y. and Millo, G. (2008), “Panel Data Econometrics in R: the plm Package,” Journal of Statistical Software, 27(2)

6. D R Haurin, D Brasington, “The impact of school quality on real house prices: Interjurisdictional effects” Journal of Housing Economics, 1996

7. E. Achtert, C. Böhm, H.-P. Kriegel, P. Kroger, A. Zimek, “Deriving Quantitative Models for Correlation Clusters”, In Proceedings of the 12th ACM International Conference on Knowledge Discovery and Data Mining (SIGKDD), Philadelphia, Pa.: 4-13, 2006.

8. Gerardi, K., Willen, P. “Subprime Mortgages, Foreclosures, and Urban Neighborhoods” (with Paul S. Willen). The B.E. Journal of Economic Analysis & Policy 9, no. 3 (2009)

9. Humphries; Stan et al. “Automatically determining a current value for a home” U.S. Patent 20070185906, Filed on Aug. 9, 2007 and Issued on Feb. 3, 2006

10. Hyndman, R. with Razbash, S. and Schmidt, D. (2012), “forecast: Forecasting functions for time series and linear models,” R package version 3.25,

11. Jost, et al., “Real estate appraisal using predictive modeling” U.S. Pat. No. 5,361,201, filed on Oct. 19, 1992 and Issued on Nov. 1, 1994

12. J M Poterba, D N Weil, R Shiller, “House price dynamics: The role of tax policy and demography” Brookings Papers on Economic Activity, 1991

13. J M Abraham, P H Hendershott, “Bubbles in metropolitan housing markets” 1994—nber.org

14. J M Clapp, C Giaccotto, “The influence of economic variables on local house price dynamics” Journal of Urban Economics, 1994—Elsevier

15. Kim, Christopher D. Y. ; et al. “Condition scoring for a property appraisal system” U.S. Patent 20050154657 Filed on Jul. 14, 2005 and Issued on Jan. 12, 2005

16. M Harter-Dreiman, “Drawing inferences about housing supply elasticity from house price responses to income shocks” Journal of Urban Economics, 2004

17. Muellbauer, J., Murphy, A. “Housing markets and the economy: the assessment” Oxford Review of Economic Policy, Volume 24, Number 1, 2008, pp. 1-33

18. Tsatsaronis, K., Zhu, H. “What drives housing price dynamics: cross-country evidence” Bank for International Settlements Quarterly Review, March 2004

19. Williams R L, “A Note on Robust Variance Estimation for Cluster-Correlated Data” Biometrics [2000, 56(2):645-646]

20. W N Goetzmann, M Spiegel, S M Wachter, “Do Cities and Suburbs Cluster?” Cityscape Vol. 3, No. 3, Emerging Issues in Urban Development (1998), pp. 193-203. Published by: US Department of Housing and Urban Development

We claim:

1. A method in a computing system having a processor for forecasting relative change in the future value of a distinguished home among a population of homes in a distinguished location each having home level attributes and location's economic variables, comprising: retrieving information about each of a plurality of economic variables and sold homes' attributes among the population that have occurred since a distinguished date; dividing the plurality of economic variables and sold homes' attributes among the population that have occurred since the distinguished date; constructing a plurality of regional, sub-regional, and state level forecasting models on relative changes in the future value on an average home respectively, each forecasting model being constructed based on information about recent economic variables; constructing a home level model on relative changes in the future value of a specific home on information based upon relative change in the average home future value in the geographic location and sold homes' attributes among the population; constructing, by the processor a relative change in future valuation meta-model based on information about economic variables in the location, and attributes of sold homes among the population; the relative change in future valuation meta-model being capable of specifying, for a combination of the relative change in future valuations produced for a home among the plurality of homes by a suite of the plurality of regional, sub-regional, state-level and percentile-models; the relative weight to be given to the relative change in future valuation produced for the home by each of the plurality of percentile-models based upon the home's attributes; for each of the plurality of relative change in future valuation percentile-models, applying the relative change in future valuation percentile-models to attributes of the distinguished home to obtain a relative change in the future valuation of the distinguished home; applying the relative change in future valuation meta-model to attributes of the distinguished home to obtain a weighting factor for each of relative change in the future valuation percentile-models; combining the valuations of the distinguished home obtained from the relative change in future valuation percentile-models in accordance with the obtained weighting factors to obtain an overall relative change in future valuation for the distinguished home; and outputting the obtained overall relative change in future valuation for the distinguished home.

2. The method of claim 1 wherein at least one of the pluralities of geographic location models is a regression model.

3. The method of claim 1 wherein at least one of the pluralities of percentile-models are derived from a clustering methodology.

4. The method of claim 1 wherein the applying and combining acts are performed for each home among the population of homes.

5. The method of claim 1 wherein the population of homes are those in a distinguished census tract.

6. The method of claim 1 wherein the population of homes are those in a distinguished city.

7. The method of claim 1 wherein the population of homes are those in a distinguished neighborhood.

8. The method of claim 1 wherein the population of homes are those in a distinguished subdivision.

9. The method of claim 1 wherein the population of homes are those in a distinguished zip code.

10. The method of claim 1 wherein the population of homes are those in a distinguished group of zip codes.

11. The method of claim 1 wherein the population of homes are those in a distinguished geographic region.

12. One or more computer memories collectively containing a trained relative change in future home valuation meta-model state data structure for a population of homes, economic variables comprising information that specifies how to map from economic variables attributable to a relative change in the future valuation for the average home in a geographic location, and from attributes of a home among the population of homes to a relative weight attributable to a relative change in future valuation produced for the home by each of a plurality of different percentile-equation models for homes among the plurality of homes, wherein the information being generated based on information about the attributes of the sold homes, such that the contents of the data structure may be used to obtain from attributes of a home among the population of homes a relative weight attributable to a relative change in future valuation produced for the home by a suite of a plurality of relative change in future valuation models at geographic area and home levels based upon the location's economic variables and home's attributes, and such that the obtained relative change in average future home value in the geographic location and percentile-equations with predicted weights may be used to combine relative change in future valuations produced for the home to obtain an overall relative change in the future valuation for the home.

13. The computer memories of claim 12 wherein the memories further contain, for each of the plurality of relative change in future valuation models, information that specifies how to produce a relative change in future valuation of a home among the population of homes in accordance with the relative change in future valuation model from geographic location's economic variables and attributes of the home, such that, for a suite of the plurality of relative change in future valuation models, the information that specifies how to produce a relative change in future valuation of a home among the population of homes in accordance with the relative change in future valuation model from location's economic variables and attributes of the home may be used to produce a relative change in future valuation of a home among the population of homes in accordance with the relative change in future valuation model from location's economic variables and attributes of the home.

14. One or more computer memories collectively containing a dynamic relative change in future home valuation model weighting data structure, comprising a plurality of entries, each entry both specifying a different one of a plurality of relative change in future valuation models for homes that are among a population of homes and specifying a relative weight to be attributed to a result produced by the specified relative change in future valuation model when applied to attributes of a home and location's economic variables to obtain relative change in future value among the population of homes, the relative weights specified by the entries having been dynamically determined based upon the attributes of the home and location to obtain relative change in future value for the home.

15. A computer-readable medium containing executable instructions capable of causing a computing system to perform a method of obtaining a relative change in the future value for a distinguished home among a population of homes each having attributes, in a distinguished geographic location each having economic variables, comprising: retrieving a plurality of relative change in future valuation regional, sub-regional, state and home level models, a suite of relative change in future valuation regional, sub-regional, state and home level models being based on information about economic variables, attributes of the sold homes, a suite of relative change in the future valuation regional, sub-regional, state and home level models being capable of producing a relative change in future valuation for a home among the population of homes based upon attributes of the home and location's economic variables; retrieving a relative change in future valuation meta-model based on information about relative change in average future home value of a location and attributes of the sold homes, the relative change in future valuation meta-model being capable of specifying, for a combination of the relative change in future valuations produced for a home among the plurality of homes by a suite of the plurality of regional, sub-regional, state-level and percentile-models; the relative weight to be given to the relative change in future valuation produced for the home by each of the plurality of percentile-models based upon the home's attributes; for each of the plurality of relative change in future valuation percentile-models, applying the relative change in future valuation percentile-model to attributes of the distinguished home to obtain a relative change in the future valuation of the distinguished home; applying the relative change in future valuation meta-model to attributes of the distinguished home to obtain a weighting factor for each of the relative changes in the future valuation percentile-models; combining the valuations of the distinguished home obtained from the relative change in future valuation percentile-models in accordance with the obtained weighting factors to obtain an overall relative change in future valuation for the distinguished home.
